(19) United States
(12) Patent Application Publication
(10) Pub. No.: US 2026/0098743 A1
(43) Pub. Date: Apr. 9, 2026

(54) SEMANTIC POINT CLOUD MAP LOCALIZATION AND MAPPING

(71) Applicant: VALEO SCHALTER UND SENSOREN GMBH, Bietigheim-Bissingen (DE)

(72) Inventors: Thomas Heitzmann, Creteil (FR); Jagdish Benashuli, Troy, MI (US); Paulo Resende, Creteil (FR)

(73) Assignee: VALEO SCHALTER UND SENSOREN GMBH, Bietigheim-Bissingen (DE)

(21) Appl. No.: 18/906,611

(22) Filed: Oct. 4, 2024

(51) Int. Cl. G01C 21/00; G01C 21/36

(52) U.S. Cl. CPC G01C 21/3841; G01C 21/3635

(57) ABSTRACT

A point cloud based semantic segmentation system includes a first vehicle, a second vehicle, and a server. The first vehicle includes a first imaging sensor, a first position sensor, and a first electronic control unit (ECU). The first ECU receives a point cloud representation of the external environment from the first imaging sensor. The first ECU associates a location of the point cloud representation based on odometry information received from the first position sensor. The server performs semantic segmentation on features in the point cloud representation and generates a map including semantically segmented features. The second vehicle is localized on the generated map using a second imaging sensor, a second position sensor, and a second ECU. The second ECU receives a second point cloud representation and second odometry information and localizes the second vehicle on the generated map based on the received information.

### BACKGROUND

Autonomous driving in dense urban environments may rely on point cloud-based semantic segmentation to understand and assess vehicle surroundings. This technology provides high-precision positional data by creating detailed representations of the environment. The semantic segmentation process categorizes various elements in the surroundings, such as pedestrians, vehicles, and infrastructure, enabling the autonomous system to navigate complex urban landscapes with enhanced awareness and accuracy. However, despite its high precision, point cloud-based semantic segmentation demands substantial computational resources. This requirement makes it challenging to deploy effectively on hardware with lower processing capabilities, prohibiting the cost of both developing and purchasing an autonomous vehicle. As a result, the industry faces a significant challenge in balancing the need for precise environmental data with the limitations and cost of the current hardware.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A point cloud based semantic segmentation system includes a first vehicle, a second vehicle, and a server. The first vehicle traverses an external environment and includes a first imaging sensor, a first vehicle position sensor, and a first Electronic Control Unit (ECU). The first imaging sensor captures a first point cloud representation of the external environment. The first vehicle position sensor measures first odometry information related to an orientation, a velocity, and an acceleration of the first vehicle. The first ECU includes a first processor, a first memory, and a first transceiver. The first processor receives the first captured point cloud representation of the external environment from the first imaging sensor, and associates a location of the first captured point cloud representation of the external environment with a location of the first vehicle on Earth. The first memory stores the first captured point cloud representation of the external environment. The first transceiver transmits the first captured point cloud representation. The server generates a map of the external environment and includes a second transceiver, a second memory, and a second processor. The second transceiver receives the first captured point cloud representation of the external environment from the first vehicle. The second memory stores a mapping module including computer readable code. The second processor executes the computer readable code forming the mapping module, where the computer readable code causes the second processor to: perform semantic segmentation on features in the first captured point cloud representation and generate a map of the external environment including the semantically segmented features of the first captured point cloud representation. The second vehicle localizes the second vehicle on the generated map of the external environment, and includes a second imaging sensor, a second vehicle position sensor, and a second ECU. The second imaging sensor captures a second point cloud representation of the external environment. The second vehicle position sensor measures second odometry information related to an orientation, a velocity, and an acceleration of the second vehicle. The second ECU includes a third transceiver, a third memory, and a third processor. The third transceiver receives the generated map of the external environment from the server. The third memory stores the second captured point cloud representation of the external environment and the generated map. The third processor receives the second captured point cloud representation of the external environment from the second imaging sensor and localizes the second vehicle on the generated map of the external environment based on the second captured point cloud representation of the external environment and the second odometry information.

A method according to one or more embodiments as described herein includes capturing, via a first imaging sensor, a first point cloud representation of an external environment of a first vehicle. The method further includes measuring, via at least a first vehicle position sensor, first odometry information related to an orientation, a velocity, and an acceleration of the first vehicle. A first processor receives the first captured point cloud representation of the external environment from the first imaging sensor. The first captured point cloud representation of the external environment is stored on a first memory. A location of the first captured point cloud representation of the external environment is associated with a location of the first vehicle on Earth. The first captured point cloud representation is transmitted, via a first transceiver, to a server. The first captured point cloud representation of the external environment is received from the first vehicle to the server via a second transceiver. A second memory stores a mapping module including computer readable code on the server. The computer readable code forming the mapping module is executed by a processor to semantically segment features in the first captured point cloud representation and generate a map of the external environment including the semantically segmented features of the first point cloud representation. The generated map of the external environment is received from the server via a third transceiver of a second vehicle. A second point cloud representation of the external environment of the second vehicle is captured via a second imaging sensor. Second odometry information related to an orientation, a velocity, and an acceleration of the second vehicle is measured via a second vehicle position sensor. The second captured point cloud representation of the external environment is received, via a third processor, from the second imaging sensor. The second captured point cloud representation of the external environment and the generated map is stored on a third memory. The second vehicle is localized on the generated map of the external environment with the third processor based on the second captured point cloud representation of the external environment and the second odometry information.

Other aspects and advantages of the claimed subject matter will be apparent from the following description and appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 depicts a vehicle traversing an environment in accordance with one or more embodiments disclosed herein.

FIGS. 2A and 2B collectively depict a visual representation of a process for removing temporary objects from an external environment in accordance with one or more embodiments disclosed herein.

FIG. 3 depicts a system in accordance with one or more embodiments disclosed herein.

FIG. 4 depicts a flowchart of a system in accordance with one or more embodiments disclosed herein.

FIGS. 5A, 5B, 5C, and 5D collectively depict a process of localizing a second vehicle on a generated map of an external environment in accordance with one or more embodiments disclosed herein.

FIG. 6 depicts a flowchart of a process for generating a map of an external environment and localizing a second vehicle on the generated map in accordance with one or more embodiments disclosed herein.

### DETAILED DESCRIPTION

Specific embodiments of the disclosure will now be described in detail with reference to the accompanying figures. In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, one or more embodiments of the invention as described herein are directed towards a system for localizing a vehicle on a generated semantic point cloud map. The semantic point cloud map is generated by capturing a first point cloud representation with a first vehicle, where the first point cloud representation is transmitted to a server that semantically segments features of the first point cloud representation. The server generates a map from the first point cloud representation and transmits the generated map to a second vehicle configured to localize itself on the generated map. As a result of this arrangement, the point cloud semantic segmentation process is realized in a cloud computing environment. In addition, affordable processing units of the second vehicle can use the semantic segmentation results without running an instance of the point cloud semantic segmentation process on the second vehicle.

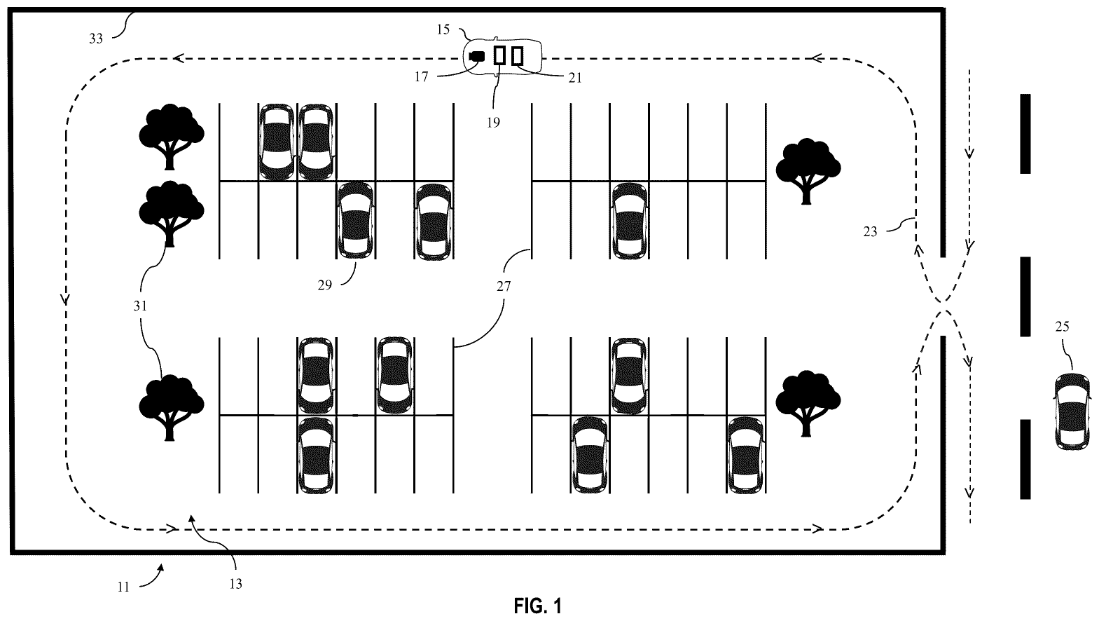

As shown in FIG. 1, a first vehicle 15 comprising at least a first imaging sensor 17, at least a first vehicle position sensor 19, and a first Electronic Control Unit (ECU) 21, traverses an external environment 11. The external environment 11 is depicted as being a rectangular shape with a single entrance and exit. Generally, the external environment 11 comprises a paved surface 13 that is a paved region of land that may be privately owned and maintained by a corporation, or publicly owned and maintained by a governmental authority. The paved surface 13 may include parking lines 27, or painted stripes, that serve to demarcate a location for a user to park or otherwise stop a vehicle's motion for a period of time.

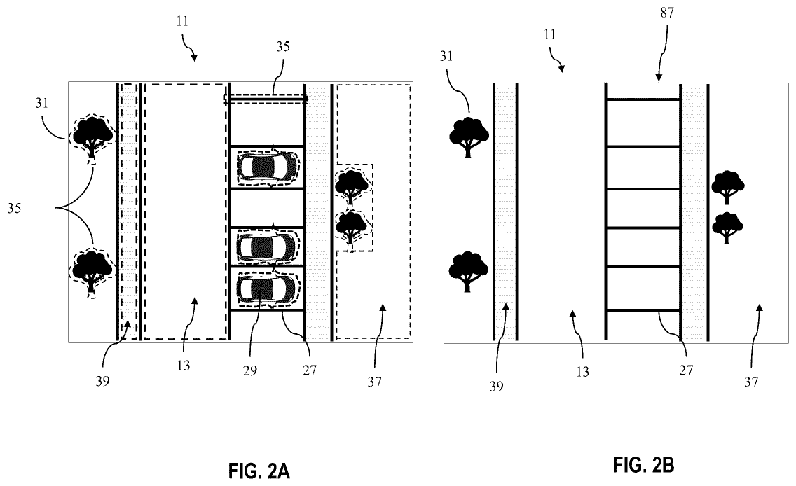

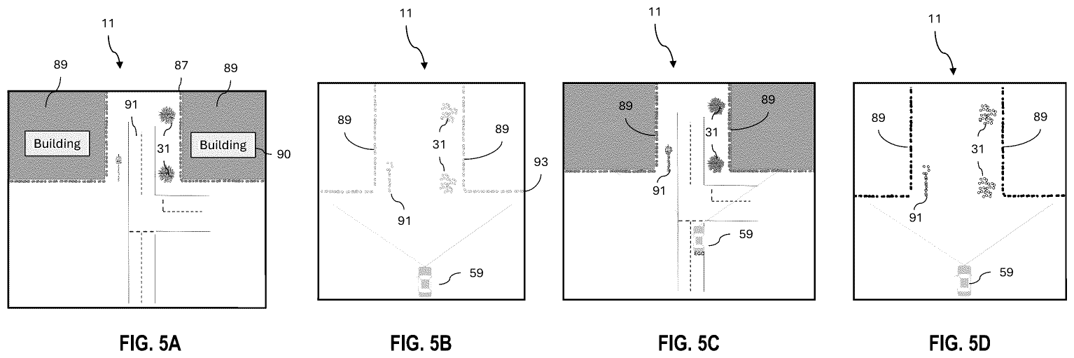

The paved surface 13 may be enclosed by either a boundary 33, such as grass (e.g., FIG. 2A), buildings (e.g., FIG. 5A), sidewalks (e.g., FIG. 2A), a property line, and/or any combination thereof. In addition, the paved surface 13 is not limited to a rectangular shape, and may be formed of one or more simple geometric shapes that combine to form an overall complex shape (i.e., a square attached to a rectangle to form an “L” shape, such as is common in a strip mall parking lot layout), and may include one or more entrances and exits. Further, the paved surface 13 may contain a plurality of features disposed in the external environment 11, which are discussed below.

Features disposed in the external environment 11 include parked vehicles 29, parking lines 27, trees 31, traffic signs (e.g., FIG. 5A), pillars (not shown), one or more traffic light(s) (not shown), sidewalks (e.g., FIG. 2A), grass (e.g., FIG. 2A), and buildings (e.g., FIG. 5A), for example. The aforementioned list of features is not all inclusive, and it will be appreciated to a person having ordinary skill in the art that other road context features, such as fire hydrants, easements, bicycle lanes, fences, and other structures may be features of the external environment 11. The names associated with the aforementioned features form classification labels for the features as well. For example, a feature identified to be a tree 31 will be provided with a semantic classification label (e.g., FIG. 5A) of “Tree”, “Flora”, or equivalent label as one output of the mapping process discussed further below.

As discussed above, the parking lines 27 are lines painted onto the paved surface 13 to denote a location for temporarily stopping a vehicle. Parking lines 27 may denote additional features as is commonly known in the art, such as an emergency vehicle lane or driving lanes for example. The parked vehicles 29 have been parked by other users in parking slots formed by the parking lines 27, such that the parked vehicles 29 form temporary barriers that the first vehicle 15 must avoid. Similarly, trees 31 and grass (e.g., FIG. 2A) represent local flora that provides an aesthetically pleasing view to a driver, and also forms impediments in the path of travel of the first vehicle 15. On the other hand, traffic vehicles 25 are vehicles that pass by, enter, traverse, and/or exit the paved surface 13. Traffic signs (e.g., FIG. 5A) indicate directions or rules to a driver, including where to stop for oncoming traffic vehicles 25, where to park, and/or a limit on the allowed speed for a traffic vehicle 25 to traverse the external environment 11, for example. Pillars are vertical, rectangular and/or cylindrical columns of stone and/or metal and/or wood used as barrier or a support for a structure, and are commonly used in multi-level parking structures to provide support to the structure. Finally, buildings (e.g., FIG. 5A) are physical structures typically housing storefronts where an exchange of goods and/or services may be facilitated.

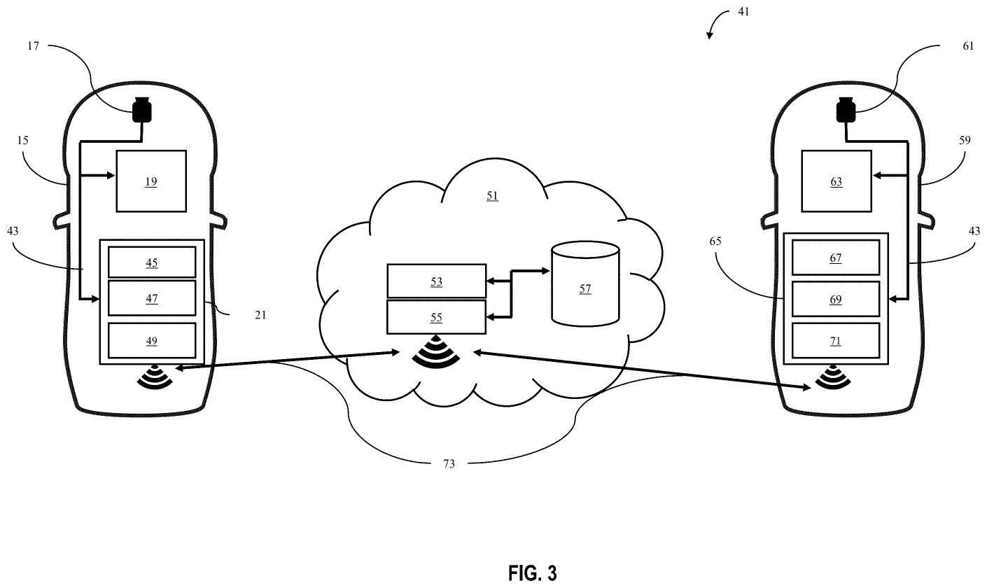

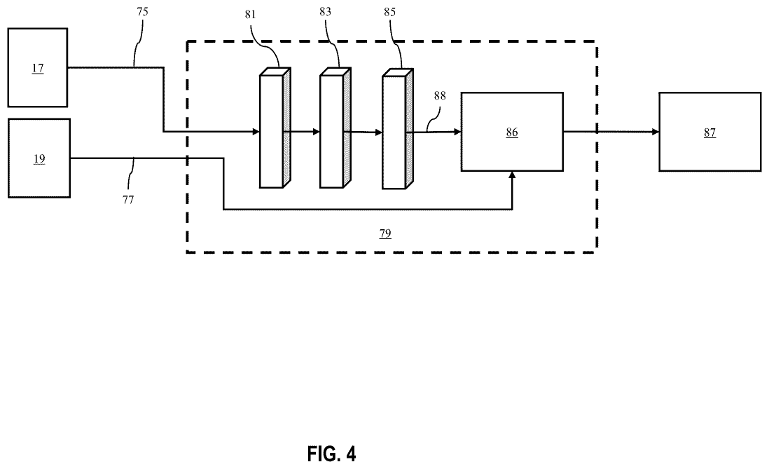

The process of mapping the external environment 11 and localizing a second vehicle (e.g., FIG. 3) on the generated map (e.g., FIG. 2B) is initiated by a first vehicle 15 entering a paved surface 13. A first vehicle path 23, which is depicted as a dotted line with arrows, shows that the first vehicle 15 enters the external environment 11 to be mapped from an outside paved surface 13 depicted as a road and/or street. The first vehicle path 23 is included for illustrative purposes to show a hypothetical first vehicle path 23 of the first vehicle 15, and is not actually painted on the paved surface 13. While the first vehicle 15 follows the first vehicle path 23 on the paved surface 13 in the external environment 11, at least a first imaging sensor 17 captures a first point cloud representation (e.g., FIG. 4) of the external environment 11. The first point cloud representation is a capture of different points using the first imaging sensor 17 to measure an area (i.e., the external environment). The first imaging sensor 17 is discussed in further detail in relation to FIG. 3, below. At the same time as the first imaging sensor 17 captures a first point cloud representation of the external environment 11, at least a first vehicle position sensor 19 measures an orientation, velocity, and/or acceleration of the first vehicle 15. The first vehicle position sensor 19 is explained in further detail in relation to FIG. 3, below.

The first vehicle 15 further comprises a first ECU 21, where the first ECU 21 comprises a first memory (e.g., FIG. 3), a first processor (e.g., FIG. 3), and a first transceiver (e.g., FIG. 3), which will be described in further detail below. The components of the first ECU 21, at least the first imaging sensor 17, and at least the first position vehicle sensor facilitate capturing a first point cloud representation (e.g., FIG. 4) of the external environment 11 of the first vehicle 15, and associating a location of the first captured point cloud representation of the external environment 11 with a location of the first vehicle 15 on Earth. The components of the first ECU 21 are further configured to upload the first captured point cloud representation to a server (e.g., FIG. 3) in order to generate a map (e.g., FIG. 2B) of the external environment 11. The first captured point cloud representation of the external environment 11 may comprise a collection of data points associated with the spatial positions and/or surfaces of the plurality of features present in the external environment 11. A point cloud representation serves as a digital representation of the real-world external environment 11, and may be processed at a later time to identify and reconstruct the external environment 11 in a computer-vison format that a vehicle may interpret for the purpose of navigation and/or autonomous driving.

Turning to FIGS. 2A and 2B, these Figures depict a visual representation of a process for semantically segmenting a plurality of features present in an external environment 11 of a first vehicle 15. The process further includes removing features identified as “temporary” features such that only permanent features remain on the generated map (e.g., FIG. 2B). This process of semantic segmentation and removal of temporary features occurs on a server (e.g., FIG. 3) after a first captured point cloud representation (e.g., FIG. 4) has been uploaded from the first vehicle 15.

FIG. 2A shows an example embodiment of an external environment 11 captured by the first vehicle 15 as a point cloud representation. For the purposes of understanding, the plurality of features of FIG. 2A are represented in an iconographic format rather than a point cloud representation. The server (e.g., FIG. 3) initially performs semantic segmentation on the plurality of features present in the external environment 11. Semantic segmentation includes identifying points associated with each feature of the plurality of features in the external environment 11 and creating “semantic masks” 35 (depicted as dashed lines) that outline feature boundaries within the external environment 11. For the sake of preventing FIG. 2A from being illegible, semantic masks 35 are not present for every feature in the embodiment, however it is to be understood that semantic masks 35 are present for multiple features in the external environment 11, and are not limited to the examples provided herein. Semantic masks 35 enclose a feature in the external environment 11 and represent individual features identified by a semantic segmentation algorithm employed by the mapping module (e.g., FIG. 4). As can be seen in FIG. 2A, the semantic masks 35 enclose the trees 31, the sidewalk 39, the parked vehicles 29, the parking lines 27, the paved surface 13, and the grass 37.

The semantic segmentation of the plurality of features may be performed by the mapping module (e.g., FIG. 4) using at least one of the following convolutional neural network (CNN) deep learning models: a Fully Convolutional Network (FCN), a U-Net, a DeepLab CNN, and a Pyramid Scene Parsing Network (PSPNet). Semantic segmentation identifies and delineates distinct features and regions within the first captured point cloud representation (e.g., FIG. 4) by categorizing each point into a predefined class (e.g., trees 31, sidewalks 39, paved surfaces 13, parked vehicles 29, grass 37), thereby assigning semantic meaning to each point in the first point cloud representation. For instance, FIG. 2A depicts separate semantic masks 35 between where the grass 37, sidewalks 39, and paved surface 13 begin, as well as the trees 31 on the grass 37, and parked vehicles 29 and parking lines 27 on the paved surface 13. Assigning semantic meaning to each point allows the mapping module to segment each feature present in the external environment 11 with semantic masks 35 such that the mapping module may further generate a map (e.g., FIG. 2B) containing the semantic masks 35 that may be interpreted for navigation and/or autonomous driving.

The mapping module (e.g., FIG. 4) performs semantic segmentation on the server (e.g., FIG. 3) after the first captured point cloud representation (e.g., FIG. 4) has been uploaded such that the map (e.g., FIG. 2B) may be generated offline and without the constraint of generating the map in real-time. This also provides a further advantage of cost efficiency as each vehicle is only equipped with the necessary hardware, and most of the processing occurs on the server (e.g., FIG. 3).

Turning to FIG. 2B, FIG. 2B depicts a map 87 of the external environment 11. In FIG. 2B, the semantic masks 35 from FIG. 2A have been removed, and the identity of the objects and features is stored as metadata of the generated map 87. Thus, FIG. 2B depicts one embodiment of the map 87 generated by the server (e.g., FIG. 3). As is further shown in FIG. 2B, the map 87 does not include any temporary features from the previous FIG. 2A, as these objects have been removed by the mapping module (e.g., FIG. 4). The identities of temporary objects and permanent objects may be stored in the mapping module in the form of a lookup table (not shown), such that the server may search the lookup table for the identity of the object, and accurately determine whether the object is considered permanent or temporary. For example, temporary features include, but are not limited to, parked vehicles 29, traffic vehicles 25, traffic cones (not shown), barriers and barricades (not shown), portable traffic signs (not shown), construction equipment (not shown), temporary traffic lights (not shown), flashing warning lights (not shown), temporary crosswalks (not shown), temporary road surfaces (not shown), water-filled barriers (not shown), temporary lane markers (not shown), portable speed bumps (not shown), and event-related objects, as they are not a fixed structure or element of the external environment 11 and will eventually be removed from the external environment 11. Permanent features include, but are not limited to, parking lines 27, sidewalks 39, grass 37, traffic lights (not shown), and trees 31, for example, as these features are considered to be part of the external environment 11 and fixed in their respective locations. Therefore, after the semantic segmentation process identifies the parked vehicles 29 as shown in FIG. 2A, the mapping module (e.g., FIG. 4) determines that parked vehicles 29 are temporary objects and removes them as shown in FIG. 2B, accordingly.

Turning to FIG. 3, FIG. 3 shows an example of a system 41 in accordance with one or more embodiments disclosed herein. As depicted in FIG. 3, the system 41 includes a first vehicle 15, a server 51, and a second vehicle 59. The first and second vehicles 15, 59 may be a passenger car, a bus, or any other type of vehicle. As shown in FIG. 3, the first vehicle 15 includes a first imaging sensor 17, a first vehicle position sensor 19, and a first Electronic Control Unit (ECU) 21. The first ECU 21 is operatively connected to the first imaging sensor 17 and the first vehicle position sensor 19 by way of a data bus 43.

The first imaging sensor 17 may comprise a Light Detection and Ranging (LiDAR) sensor, however the first imaging sensor 17 may alternatively be embodied as a camera, a radar sensor, an ultrasonic sensor, or an infrared sensor without departing from the nature of the specification. Additionally, embodiments of the first vehicle 15 are not limited to including only a first imaging sensor 17, and may include more imaging sensors based on budgeting, design, or longevity constraints. The first imaging sensor 17 is configured to capture a first point cloud representation (e.g., FIG. 4) of the external environment 11 of the first vehicle 15. The first captured point cloud representation may include a plurality of features as previously discussed, such as, but not limited to: parking lines 27, traffic signs (e.g., FIG. 5A), buildings (e.g., FIG. 5A), pillars, parked vehicles 29, sidewalks 39, trees 31, and grass 37. As previously discussed, the first point cloud representation (e.g., FIG. 4) of the external environment 11 may comprise a collection of data points associated with the spatial positions and/or surfaces of the plurality of features present in the external environment 11.

The first vehicle 15 further includes at least a first vehicle position sensor 19 configured to measure first odometry information (e.g., FIG. 4) related to an orientation, a velocity, and an acceleration of the first vehicle 15. The first vehicle position sensor 19 may comprise a Global Navigation Satellite Systems (GNSS) unit, a Global Positioning System (GPS) Real Time Kinematics (RTK) unit, an Inertial Measurement Unit (IMU), and/or a wheel encoder. The first vehicle position sensor 19 is configured to measure first odometry information associated with the movement of the first vehicle 15 through the external environment 11. The GNSS unit may provide a GNSS position of the first vehicle 15 using satellite signal triangulation that may be associated with the first captured point cloud representation (e.g., FIG. 4) when the first captured point cloud representation is uploaded to the server 51. The GPS RTK functions in a similar fashion by pairing satellite signal triangulation with vehicle kinematics to determine the location of the first vehicle 15. Further, the server 51 stores a global map formed from a plurality of maps 87 generated when a first vehicle 15 and/or a second vehicle 59 traverse an external environment 11 and transmit a first captured point cloud representation (e.g., FIG. 4) and/or a second captured point cloud representation (e.g., FIG. 5B) to the server 51.

To limit the amount of data downloaded by a user, the GNSS position (and/or the information collected from an IMU and/or wheel encoder) of a user is used by the server 51 to determine where on the global map a user is located, such that maps 87 of varying sizes including a country, a state, a county, or a city may be downloaded to a second vehicle 59 based on the second vehicle's 59 current GNSS position. The varying size of the map 87 downloaded to the second vehicle 59 is determined by an operator and/or a user. For example, if a user is planning a cross-country road trip involving traversing multiple states, an ideal map size to download may be a generated map 87 encompassing an entire country the user resides in, as the second vehicle 59 may not always maintain a data connection 73 to the server 51 and may pass through different cities, counties, and states. On the other hand, if a user intends to drive within a city, then a preferable map size to download may be a generated map 87 encompassing a city the user resides in in an effort to minimize unnecessary data pertaining to locations the second vehicle 59 may not be traversing. Additionally, an operator may designate a default size for the map value, where the default map size may be a map 87 encompassing a city the user currently resides in.

In addition, the IMU and wheel encoder of the first vehicle position sensor 19 are configured to facilitate the collection of angular movement data related to the first vehicle 15. The IMU utilizes accelerometers and gyroscopes to measure changes in velocity and orientation of the first vehicle 15, which provides a real-time acceleration and angular velocity of the first vehicle 15. The wheel encoder, disposed on the main drive shaft or individual wheels of the first vehicle 15, measures rotations through a Hall Effect sensor, and converts the rotation of the wheels into the distance traveled by the first vehicle 15 and velocity of the first vehicle 15. If the GNSS unit is unable to establish an uplink signal with the satellite, such as when the first vehicle 15 is in an underground paved surface 13, the first vehicle 15 is still capable of capturing a first point cloud representation (e.g., FIG. 4) of the external environment 11 with accurate location information using the first imaging sensor 17 and the remaining hardware of the first vehicle position sensor 19 (i.e., the IMU and the wheel encoder). Thus, as a whole, the first vehicle position sensor 19 serves to provide orientation and location data related to the position of the first vehicle 15 in the external environment 11.

The first ECU 21 of the first vehicle 15 comprises a first memory 45, a first processor 47, and a first transceiver 49. The first ECU 21 is thus configured to execute a series of instructions, formed as computer readable code, that causes the first ECU 21 to receive the first captured point cloud representation (e.g., FIG. 4) of the external environment 11. The computer readable code further causes the first ECU 21 to receive the first odometry information (e.g., FIG. 4) from the first imaging sensor 17 and the first vehicle position sensor 19, respectively, and transmit the first captured point cloud representation (e.g., FIG. 4) to the server 51. The first memory 45 of the first vehicle 15 is formed as a non-transient storage medium such as flash memory, Random Access Memory (RAM), a Hard Disk Drive (HDD), a Solid State Drive (SSD), a combination thereof, or equivalent devices. The first memory 45 of the first vehicle 15 is configured to store the first captured point cloud representation of the external environment of the first vehicle.

The first processor 47 may be formed as a series of microprocessors, an integrated circuit, or associated computing devices. The first processor 47 of the first vehicle 15 is configured to receive the first captured point cloud representation (e.g., FIG. 4) of the external environment 11 from at least the first imaging sensor 17. The first processor 47 is further configured to associate a location of the first captured point cloud representation of the external environment 11 with a location of the first vehicle 15 on Earth. The location may be determined from the first odometry information (e.g., FIG. 4) of the first vehicle 15.

Finally, a first transceiver 49 of the first vehicle 15 is configured to upload the first captured point cloud representation (e.g., FIG. 4) to the server 51. As described herein, a “transceiver” refers to a device that performs both data transmission and data reception processes, such that the first transceiver 49 encompasses the functions of a transmitter and a receiver in a single package. In this way, the first transceiver 49 includes an antenna (such as a monitoring photodiode), and a light source such as an LED, for example. Alternatively, the first transceiver 49 may be embodied as solely a transmitter, as the first vehicle 15 is intended to perform the action of capturing and uploading the first captured point cloud representation (e.g., FIG. 4) of the external environment 11 to the server 51. The server 51 generates a map 87 of the external environment 11 including the first captured point cloud representation (e.g., FIG. 4) and uploads the generated map 87 to a second vehicle 59. However, the first vehicle 15 may be repurposed as a second vehicle 59 for reasons discussed further below, and thus a transceiver (or a transmitter and a receiver) may be necessary in order to receive the generated map 87 from the server 51.

The server 51 comprises a second memory 57, a second processor 53, and a second transceiver 55, where the components of the server 51 are operatively connected by way of a data bus 43. The second memory 57 of the server 51 is formed as a non-transient storage medium such as flash memory, RAM, a HDD, a SSD, a combination thereof, or equivalent devices. The second memory 57 is configured to store a mapping module (e.g., FIG. 4) comprising computer readable code. The computer readable code, may, for example, be written in a language such as C++, C #, Java, MATLAB, or equivalent computing languages.

The second processor 53, which may be formed as a series of microprocessors, an integrated circuit, or associated computing devices, is configured to execute the computer readable code forming the mapping module (e.g., FIG. 4) as discussed above. Upon receiving the first captured point cloud representation (e.g., FIG. 4) from the first vehicle 15, the mapping module semantically segments a plurality of features present in the first point cloud representation and labels identified features with semantic classification labels. After semantic segmentation, the mapping module generates a map 87 of the external environment 11 from the semantically segmented first captured point cloud representation having removed any temporary features and aligned and stitched with a plurality of previously generated maps 87 to form a global map. With regard to the process of semantic segmentation and generation of the map 87 of the external environment 11, semantic segmentation is performed on the server 51 without a real-time processing constraint. The map 87 is generated from a combination of information from the first vehicle 15 and/or the second vehicle 59 after completing the process of semantic segmentation and removing any temporary features. In addition, performing semantic segmentation on the server 51 allows for manual checks and corrections of the semantic segmentation process by an operator. This can be helpful if the mapping module is uncertain in the semantic segmentation process, ensuring the generated maps 87 may be as accurate as possible.

The second transceiver 55, which is configured to receive the first captured point cloud representation (e.g., FIG. 4) from the first vehicle 15, is further configured to transmit the generated map 87 of the external environment 11 to the second vehicle 59. The second transceiver 55 may alternatively be split into a transmitter and receiver, where the receiver serves to receive the first captured point cloud representation from the first vehicle 15, and the transmitter serves to transmit the generated map 87 and embedded classification labels to the second vehicle 59. In addition, the second transceiver 55 of the server 51 is further configured to receive a second captured point cloud representation (e.g., FIG. 5B) of the external environment 11 from the second vehicle 59 if the second vehicle 59 captures previously unclassified features in the external environment 11.

The second vehicle 59 comprises a second imaging sensor 61, a second vehicle position sensor 63, and a second ECU 65. The second ECU 65 is operatively connected to the second imaging sensor 61 and the second vehicle position sensor 63 by way of a data bus 43. The second imaging sensor 61 of the second vehicle 59 may comprise at least one of: a LiDAR sensor, a camera, a radar sensor, and an infrared sensor. Additionally, embodiments of the second vehicle 59 are not limited to including only a second imaging sensor 61, and may include additional imaging sensors based on budgeting, design, or longevity constraints. The second imaging sensor 61 is configured to capture a second point cloud representation (e.g., FIG. 5B) of the external environment 11 of the second vehicle 59. The second captured point cloud representation may include a plurality of features as previously discussed. The plurality of features present in the second captured point cloud representation may be less than, the same as, or more than the plurality of features present in the first captured point cloud representation (e.g., FIG. 4) and the generated map 87. The second captured point cloud representation is used in localizing the second vehicle 59 by comparing the location of the plurality of features present in the second captured point cloud representation and the generated map 87. The localization process is discussed below in relation to FIGS. 5A-5D.

The second vehicle 59 further includes at least a second vehicle position sensor 63 configured to measure second odometry information related to an orientation, a velocity, and an acceleration of the second vehicle 59. The second vehicle position sensor 63 may comprise a GNSS unit, a GPS RTK unit, an IMU, and/or a wheel encoder. The second vehicle position sensor 63 is configured to gather second odometry information associated with the movement of the second vehicle 59 through the external environment 11. The GNSS unit provides a GNSS position of the second vehicle 59 using satellite signal triangulation that may be used to assist in localizing the second vehicle 59 in the external environment 11 with respect to the generated map 87. Additionally, the GNSS position of the second vehicle 59 is associated with the second captured point cloud representation (e.g., FIG. 5B) when uploaded to the server 51. The GPS RTK functions in a similar fashion by paring satellite signal triangulation with vehicle kinematics to determine the location of the second vehicle 59. It is noted that the first vehicle position sensor 19 and the second vehicle position sensor 63 may be embodied as separate types of sensors or the same type of sensor.

Further, the IMU and wheel encoder of the second vehicle position sensor 63 are configured to facilitate the collection of angular movement data related to the second vehicle 59. The IMU utilizes accelerometers and gyroscopes to measure changes in velocity and orientation of the second vehicle 59, which provides a real-time acceleration and angular velocity of the second vehicle 59. The wheel encoder, disposed on the main drive shaft or individual wheels of the second vehicle 59, measures rotations through a Hall Effect sensor, and converts the rotation of the wheels into the distance traveled by the second vehicle 59 and velocity of the second vehicle 59. If the GNSS unit is unable to establish an uplink signal with the satellite, such as when the second vehicle 59 is in an underground paved surface 13, the second vehicle 59 is still capable of performing localization using the second imaging sensor 61 and the remaining hardware of the second vehicle position sensor 63 (i.e., the IMU and the wheel encoder). Thus, as a whole, the second vehicle position sensor 63 serves to provide orientation and location data related to the position of the second vehicle 59 in the external environment 11 to assist in localization of the second vehicle 59.

The second ECU 65 of the second vehicle 59 comprises a third memory 67, a third processor 69, and a third transceiver 71. The second ECU 65 is thus configured to execute a series of instructions, formed as computer readable code, that causes the second ECU 65 to receive the generated map 87 of the external environment 11 from the server 51, and localize the second vehicle 59 on the generated map 87. The third memory 67 of the second vehicle 59 is formed as a non-transient storage medium such as flash memory, RAM, a HDD, a SDD, a combination thereof, or equivalent devices. The third memory 67 is configured to store the second captured point cloud representation (e.g., FIG. 5B) of the external environment 11 and the generated map 87.

The third processor 69 may be formed as a series of microprocessors, an integrated circuit, or associated computing devices. The third processor 69 of the second vehicle 59 is configured to receive the second captured point cloud representation (e.g., FIG. 5B) of the external environment 11 from at least the second imaging sensor 61. In addition, and as discussed below, the third processor 69 receives the generated map 87 from the server 51 via the third transceiver 71. With both the generated map 87 and the second captured point cloud representation, the third processor 69 is further configured to localize the second vehicle 59 on the generated map 87 based on the second captured point cloud representation and the second odometry information. This process is discussed further in depth in relation to FIGS. 5A-5D below.

The third transceiver 71, which is configured to receive the generated map 87 of the external environment 11 from the server 51, is further configured to transmit the second captured point cloud representation (e.g., FIG. 5B) to the server 51 if the second captured point cloud representation captures previously unclassified features in the external environment 11, as discussed in further detail below in relation to FIGS. 5A-5D. The third transceiver 71 may alternatively be split into a transmitter and receiver, where the receiver serves to receive the generated map 87 from the server 51, and the transmitter serves to transmit the second captured point cloud representation to the server 51.

In order to share data between the first vehicle 15, the server 51, and the second vehicle 59, data is transmitted by way of the first, second, and third transceivers 49, 55, 71, respectively. The first, second, and third transceivers 49, 55, 71 form a wireless data connection 73 that may be embodied as forms of data transmission including a Wireless-Fidelity (Wi-Fi) connection, a Worldwide Interoperability for Microwave Access (WiMAX) connection, a Vehicle to Everything (V2X) connection, a Fourth Generation (4G) Long-Term Evolution (LTE) connection, a Fifth Generation (5G) connection, contemplated future cellular data connections such as a Sixth Generation (6G) connection, a Bluetooth connection, a Light Fidelity (Li-Fi) connection, a cellular connection, a satellite data transmission, or equivalent data transmission protocols. During a data transmission process, the first transceiver 49 of the first vehicle 15 is configured to upload a first captured point cloud representation (e.g., FIG. 4) to the server 51, where the server 51 generates a map 87 of the external environment 11 based on the first captured point cloud representation and uploads the generated map 87 to the second vehicle 59. The second vehicle 59 additionally may upload a second captured point cloud representation (e.g., FIG. 5B) to the server 51 in order to update the generated map 87 in the scenario that the external environment 11 has changed since the generated map 87 was initially generated, such that any new and previously unclassified features in the second point cloud representation may be classified by the server 51. The first vehicle 15 and the second vehicle 59 communicate with the server 51 separately.

Turning to FIG. 4, FIG. 4 shows a mapping module 79 used to generate a map 87 of an external environment 11. The mapping module 79 is typically housed on the server 51 such that only the server 51 performs semantic segmentation. The mapping module 79 is formed of computer code as discussed above.

As discussed previously, the mapping module 79 receives data from the first vehicle 15. Specifically, the first vehicle 15 transmits, via the first transceiver 49, a first captured point cloud representation 75 and first odometry information 77. The first captured point cloud representation 75 is captured by at least a first imaging sensor 17, and the first odometry information 77 is measured by at least a first vehicle position sensor 19. The first imaging sensor 17 may comprise at least one of: a LiDAR sensor, a camera, a radar sensor, and an infrared sensor. The first vehicle position sensor 19 may comprise a Global Navigation Satellite Systems (GNSS) unit, and/or an IMU, and/or a wheel encoder. The first odometry information 77 includes the previously discussed data related to an orientation, and/or a velocity, and/or an acceleration of the first vehicle 15. The first odometry information 77 is used to determine the location of the first vehicle 15 such that the location of the first captured point cloud representation 75 is known.

The first captured point cloud representation 75 is input into a semantic segmentation deep learning neural network configured to determine a location and identity of the plurality of features disposed in the first captured point cloud representation 75. The semantic segmentation deep learning neural network is formed by an input layer 81, one or more hidden layers 83, and an output layer 85. The input layer 81 serves as an initial layer for the reception of the first captured point cloud representation 75. The one or more hidden layers 83 include layers such as convolution and pooling layers, which are further discussed below. The number of convolution layers and pooling layers of the hidden layers 83 depend upon the specific network architecture and the algorithms employed by the semantic segmentation deep learning neural network, as well as the number and type of features that the network is configured to detect. For example, a neural network flexibly configured to detect multiple types of features will generally have more layers than a neural network configured to detect a single feature. Thus, the specific structure of the layers 81-85, including the number of hidden layers 83, is determined by a developer of the mapping module 79 and/or the system 41 as a whole.

In general, a convolution filter convolves the input first captured point cloud representation 75 of the external environment 11 with learnable filters, extracting low-level features such as the outline of features and the color of features. Subsequent layers aggregate these features, forming higher-level representations that encode more complex patterns and textures associated with the features. Through training, the neural network refines weighted values associated with determining different types of features in order to recognize semantically relevant features for different classes of features. The final layers of the convolution operation employ the learned features to make predictions about the identity and location of the features.

On the other hand, a pooling layer reduces the dimension of outputs of the convolution layer into a down-sampled feature map. For example, if the output of the convolution layer is a feature map with dimensions of 4 rows by 4 columns, the pooling layer may down-sample the feature map to have dimensions of 2 rows by 2 columns, where each cell of the down-sampled feature map corresponds to 4 cells of the non-down-sampled feature map produced by the convolution layer. The down-sampled feature map allows the feature extraction algorithms to pinpoint the general location of various objects detected with the convolution layer and filter. Continuing with the example provided above, an upper left cell of a 2×2 down-sampled feature map will correspond to a collection of 4 cells occupying the upper left corner of the feature map. This reduces the dimensionality of the inputs to the semantic feature-based deep learning neural network formed by the layers 81-85, such that an image including multiple pixels can be reduced to a single output of the location of a specific feature within the image.

In the context of the various embodiments described herein, a feature map may reflect the location of various physical objects present on a paved surface 13, such as the locations of parking lines 27 and trees 31. The feature map also includes semantic classification labels associated with each identified object. Examples of semantic classification labels include a label of “Road” corresponding to the semantic mask 35 associated with a paved surface 13, or a label of “Grass” or “Easement” for the grass 37. Examples of object detection algorithms utilized to create the feature map include You Only Look Once (Yolo), Single Shot Detection (SSD), and associated detection algorithms as will be appreciated by a person having ordinary skill in the art. Subsequently, the feature map is converted by the hidden layer 83 into semantic masks 35 that are superimposed on the first captured point cloud representation 75 to denote the location of various features identified by the feature map.

After the hidden layers 83 of the deep learning neural network have semantically segmented the plurality of features present in the first captured point cloud representation 75, the output layer 85 outputs a semantically segmented version of the first captured point cloud representation 88. The semantically segmented point cloud map includes semantic masks 35 for the plurality of features, where the plurality of features have an associated determined identity. The semantically segmented first captured point cloud representation 88 including the semantic classification labels embedded therein is sent to a post-processing module 86 in order to remove any temporary features present, and further stitch and align the generated map 87 on a global map formed from a plurality of previously generated maps 87. In addition, the post-processing module 86 receives the first odometry information 77 in order to determine the location of the generated map 87 on the global map relative to the plurality of previously generated maps 87.

In the case that a temporary feature is present in the semantically segmented first captured point cloud representation 88, the post-processing module 86 is configured to remove the temporary feature from the semantically segmented first captured point cloud representation 88. A feature is determined to be temporary when it is not a fixed structure or element of the external environment 11 and will eventually be removed from the external environment 11. Examples of temporary features include, but are not limited to, parked vehicles 29 and traffic cones, as they will eventually be removed from external environment 11, as opposed to permanent features such as buildings (e.g., FIG. 5A), trees 31, sidewalks 39, and parking lines 27. Example temporary features are stored in a lookup table (not shown) that is accessed by the post-processing module 86 to determine if an identified feature is to be deemed temporary.

After the post-processing module 86 removes any temporary features present in the semantically segmented first captured point cloud representation 88 such that only permanent features remain the post-processing module 86 stitches the generated map 87 (i.e., the semantically segmented first captured point cloud representation 88 containing only permanent features) with the plurality of previously generated maps 87 to form a global map. The post-processing module 86 uses the first odometry information 77 (i.e., a GNSS position and/or an orientation, a velocity, and an acceleration) to determine the location of the semantically segmented first captured point cloud representation 88. With the location of the semantically segmented first captured point cloud representation 88, the post-processing module 86 may store the semantically segmented first captured point cloud representation 88 as part of the global map relative to the locations of previously generated maps 87. The post-processing module further aligns and stitches the semantically segmented first captured point cloud representation 88 with the plurality of previously generated maps 87 forming the global map, such that the semantically segmented first captured point cloud representation 88 is correctly oriented.

The alignment and stitching process may initiate by matching known features, such as buildings (e.g., FIG. 5A), paved surfaces 13 (i.e., streets and roads), and entrances and/or exits, in order to achieve a correct alignment of the semantically segmented first captured point cloud representation 88 relative to the plurality of previously generated maps 87 forming the global map. Then, the semantically segmented first captured point cloud representation 88 is stitched into its corresponding location of the global map relative to the plurality of previously generated maps 87. The output of the post-processing module 86 includes a generated map 87 (i.e., the semantically segmented first captured point cloud representation 88 containing only permanent features) that has been aligned and stitched to the plurality of previously generated maps 87 forming the global map. As previously discussed, the second transceiver 55 of the server 51 transmits the generated map 87 to the second vehicle 59 in order for the second vehicle 59 to perform localization.

Turning to FIGS. 5A, 5B, 5C, and 5D, these Figures depict an example process of localizing a second vehicle 59 on a generated map 87 of an external environment 11. With respect to FIG. 5A, FIG. 5A shows the generated map 87 that the second vehicle 59 receives from the server 51. The generated map 87 comprises a semantically segmented version of a first captured point cloud representation 75. The generated map 87 only contains permanent features, including buildings 89, a traffic sign 91, and trees 31. The permanent features are each assigned an associated semantic classification label in the generated map 87. One example of such a classification label is depicted in FIG. 5A as a semantic classification label 90 associated with a building 89. For the sake of visual clarity, classification labels have not been depicted for each identified object, but it will be appreciated that the generated map 87 includes classification labels 90 for each object.

FIG. 5B depicts a second captured point cloud representation 93 of the external environment 11 of the second vehicle 59. The second vehicle 59 may arrive at an external environment 11 that a first vehicle 15 has previously traversed. The first vehicle 15 has previously uploaded a first captured point cloud representation 75 of the external environment 11 to the server 51, and the server 51 has previously generated a map 87. The second vehicle 59, upon traversing an external environment 11 that a generated map 87 already exists for, initially captures a second captured point cloud representation 93 of the external environment 11. The plurality of features present in the second captured point cloud representation 93 of FIG. 5B are not classified. However, the points in the second captured point cloud representation 93 can be seen to roughly resemble the position of the plurality of features in FIG. 5A. From a human's point of view, it may be possible to discern the outlines of the plurality of features, including the buildings 89, the traffic sign 91, and the trees 31. However, the second vehicle 59 is unable to interpret the second captured point cloud representation 93 alone, and requires the additional assistance of the generated map 87.

Turning to FIG. 5C, FIG. 5C depicts the merging of the generated map 87 and the second captured point cloud representation 93. The third processor 69 of the second vehicle 59 attempts to localize the second vehicle 59 on the generated map 87 based on the second captured point cloud representation 93. The localization process includes aligning the second captured point cloud representation 93 with the generated map 87, matching points that appear in the same location.

As shown in FIG. 5C, the points from the second captured point cloud representation 93 in FIG. 5B are shown overlapping with the classified features in the generated map 87 of FIG. 5A. When the third processor 69 successfully merges the second captured point cloud representation 93 with the generated map 87, the third processor 69 matches the class of the plurality of features from the generated map 87 onto the points associated with the plurality of features in the same location in the second captured point cloud representation 93. This results in the second vehicle 59 having a semantically segmented point cloud representation, as well as the second vehicle 59 being localized in relation to the segmented point cloud representation. That is, as a result of the localization process the second vehicle 59 is apprised of its location and orientation in the external environment, and is further apprised of semantic labels for each detected feature in the local environment. Because the server 51 creates the semantic masks, and not the second vehicle 59, the process of FIGS. 5A-5D ultimately allows the second vehicle 59 to be apprised of the semantic masks for identified objects without requiring hardware such as graphics card that may be necessary for the server 51 to perform the mapping process.

Although not shown in the current example embodiment, if the second captured point cloud representation 93 contains a grouping of points that were unclassified in the generated map 87, the second vehicle 59 may send the second captured point cloud representation 93 to the server 51 in order to generate a new map 87 to update the previous version. A grouping of unclassified points may occur when features are added or repositioned from when the map 87 was generated. Similarly, any features that have been removed from when the map 87 was generated may also result in uploading the second captured point cloud representation 93 to the server 51. This may occur when an external environment 11 undergoes construction, inclement weather destroys flora and/or buildings 89, and/or when additional flora is planted.

Specifically, the second captured point cloud representation 93 is uploaded to the server 51 if the third processor 69 localizes the second vehicle 59 with a confidence level of less than a predetermined threshold (e.g., 90% confidence) when merging the second captured point cloud representation 93 with the generated map 87. The confidence level is determined by the third processor 69 during the localization process by comparing a percentage of features (i.e., points) on the second captured point cloud representation 93 matched to the features on the generated map 87. In this way, minor features, such as detritus (i.e., litter), may have a minor effect on the confidence level due to the small size of the feature, and may not warrant uploading the second captured point cloud representation 93 to the server 51. In addition, the confidence level of the third processor 69 may not result in 100% even if the features in the generated map 87 and the second captured point cloud representation 93 are the same due to differences such as lighting, flora growing and/or wilting, and a difference in the positioning of the second imaging sensor 61 on the second vehicle 59 from the positioning of the first imaging sensor 17 on the first vehicle 15. However, if the features present in both the generated map 87 and the second captured point cloud representation 93 are the same, then the confidence level may reasonably be above the predetermined threshold, and therefore would not warrant uploading the second captured point cloud representation 93 to the server 51.

On the other hand, if the confidence level falls below the predetermined threshold, due to the previously discussed reasons of the addition, removal, or repositioning of features, then the second captured point cloud representation 93 may be uploaded to the server 51 in order to update the relevant portion of the generated map 87. Further, different external environments 11 may require a different confidence level threshold for uploading the second captured point cloud representation 93 at an operator's discretion. For example, an external environment comprising a neighborhood street may undergo relatively little change between a first vehicle 15 and a second vehicle 59 traversing the external environment 11, as parked vehicles 29 and additional features may remain in the same location. However, an external environment 11 comprising a commercial setting, such as a parking lot for one or more businesses, may experience increased variation, mainly in the amount and location of parked vehicles 29. While parked vehicles 29 are temporary features, semantic segmentation of the plurality of features is performed on the server 51 such that the third processor 69 of the second vehicle 59 may not recognize the identity of unclassified objects. The variation of parked vehicles 29 in a commercial setting external environment 11 may result in the third processor 69 consistently resulting in a confidence level less than the aforementioned predetermined threshold of 90%. In this way, an operator may designate different confidence level thresholds (i.e., less than 80% and/or less than 70%) according to different types of external environments 11 based on the amount of variability commonly experienced.

Turning to FIG. 5D, FIG. 5D depicts the second captured point cloud representation 93 with the plurality of features being classified. FIG. 5D is presented in computer-vision, such that the second vehicle 59 is capable of interpreting the second captured point cloud representation 93 with classified features for the purposes of navigation and/or autonomous driving. FIG. 5D shows that the buildings 89, the trees 31, and the traffic sign 91 that were previously unclassified in FIG. 5B have adopted the classifications of the features identified in the generated map 87 of FIG. 5A. The second vehicle 59 has fully localized itself in the external environment 11 as a result of merging the second captured point cloud representation 93 with the generated map 87, as well as using the second odometry information to determine an accurate orientation and position of the vehicle relative to the generated map 87.

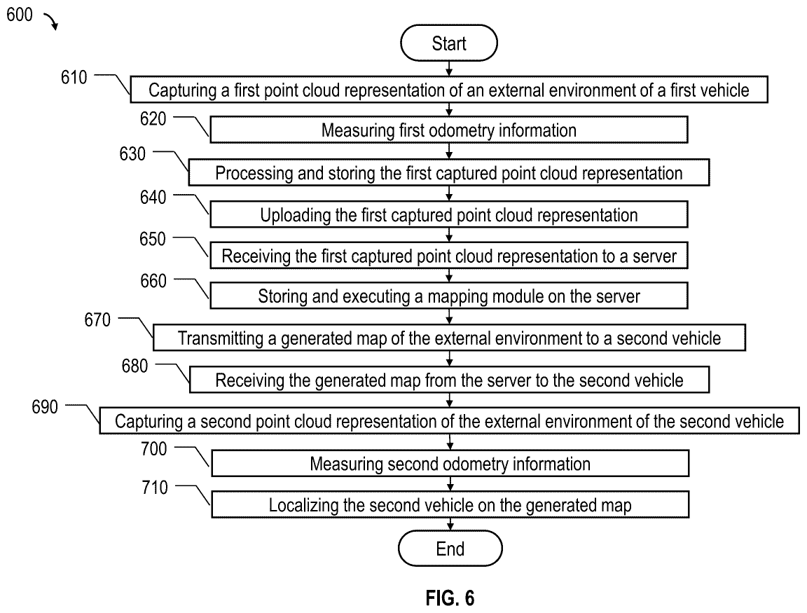

Turning to FIG. 6, FIG. 6 depicts a method 600 for generating a map 87 and localizing a second vehicle 59 on the map 87 in accordance with one or more embodiments of the invention. While the various blocks in FIG. 6 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively. Similarly, a single block may encompass multiple actions, or multiple blocks may be performed in the same physical action.

The method of FIG. 6 initiates with Step 610, which includes capturing a first point cloud representation 75 of an external environment 11 of a first vehicle 15. The first point cloud representation 75 is captured by way of at least a first imaging sensor 17 of the first vehicle 15. The first imaging sensor 17 may comprise at least one of: a Light Detection and Ranging (LiDAR) sensor, a camera, a radar sensor, an ultrasonic sensor, or an infrared sensor. Additionally, the first vehicle 15 is not limited to only a first imaging sensor 17, and may comprise more than one imaging sensor based on budgeting, design, or longevity constraints.

Further the first captured point cloud representation 75 may comprise a collection of data points associated with the spatial positions and/or surfaces of the plurality of features present in the external environment 11. The plurality of features present in the external environment 11 may include parked vehicles 29, parking lines 27, traffic signs 91, buildings 89, pillars, trees 31, sidewalks 39, and grass 37.

In Step 620, at least a first vehicle position sensor 19 measures first odometry information 77 related to an orientation, a velocity, and an acceleration of the first vehicle 15. The first vehicle 15 is not limited to only a first vehicle position sensor 19, and may comprise more than one vehicle position sensor based on budgeting, design, or longevity constraints. The first vehicle position sensor 19 may comprise a Global Navigation Satellite Systems (GNSS) unit, a Global Positioning System (GPS) Real Time Kinematics (RTK) unit, an Inertial Measurement Unit (IMU), and/or a wheel encoder. As previously described in relation to FIG. 3, the first odometry information 77 is associated with the movement of the first vehicle 15 through the external environment 11. Thus, the first odometry information 77 determines the location of the first vehicle 15 on Earth, either by way of the GNSS unit used to measure the GNSS location of the vehicle, the GPS RTK unit used to determine the location of the vehicle by pairing satellite signal triangulation with vehicle kinematics, or a combination of the orientation, and/or the velocity, and/or the acceleration of the first vehicle 15 from the IMU and the wheel encoder in order to determine the location of the vehicle relative to a known location in the external environment 11.

Step 630 includes processing and storing the first captured point cloud representation 75. The first processor 47 receives the first captured point cloud representation 75 of the external environment 11 from at least the first imaging sensor 17. The first captured point cloud representation 75 of the external environment is also stored on the first memory 45. The first memory 45 of the first vehicle 15 is formed as a non-transient storage medium such as flash memory, Random Access memory (RAM), a Hard Disk Drive (HDD), a Solid State Drive (SSD), a combination thereof, or equivalent devices. The first processor 47 further associates a location of the first captured point cloud representation of the external environment with a location of the first vehicle on Earth. The first odometry information 77 of the first vehicle 15 may be used to determine the location of the first vehicle 15, including a GNSS position of the vehicle, and thus, the location of the first captured point cloud representation 75.

In Step 640, a first transceiver 49 uploads the first captured point cloud representation 75 to a server 51. The first transceiver 49 of the first vehicle 15 is a device with the capabilities of performing both data transmission and data reception processes, such that the first transceiver 49 encompasses the functions of a transmitter and a receiver in a single package. The first vehicle 15 is typically used for capturing a first point cloud representation 75, measuring first odometry information 77 of the first vehicle 15, and uploading the first captured point cloud representation 75 and the first odometry information 77 to the server 51.

In Step 650, a second transceiver 55 receives the first captured point cloud representation 75. The second transceiver 55 is housed on a server 51 configured to generate a map 87 from the first captured point cloud representation 75. The second transceiver 55 comprises similar capabilities to the first transceiver 49 as previously discussed. In addition to receiving the first captured point cloud representation 75 from the first vehicle 15, the second transceiver 55 is further configured to receive the first odometry information 77 from the first vehicle 15 to assist in generating the map 87 of the external environment 11.

Step 660 includes storing and executing a mapping module 79 on the server 51. The mapping module 79 is stored on a second memory 57 in the form of computer readable code. The second memory 57, similar to the first memory 45, is formed as a non-transient storage medium such as flash memory, RAM, a HDD, an SSD, a combination thereof, or equivalent devices. Further, the computer readable code of the mapping module 79, may, for example, be written in a language such as C++, C #, Java, MATLAB, or equivalent computing languages suitable for performing semantic segmentation based on the first captured point cloud representation 75, as well as generating a map 87 of the external environment 11 based on the semantically segmented features of the first captured point cloud representation 75.

The mapping module 79 is executed by a second processor 53 of the server 51, where the second processor 53 may be formed as a series of microprocessors, an integrated circuit, or associated computing devices. The mapping module 79 includes semantically segmenting a plurality of features in the first captured point cloud representation 75. The mapping module 79 comprises a semantic segmentation deep learning neural network that uses at least one of the following Convolutional Neural Network (CNN) deep learning models in order to semantically segment the plurality of features present in the first captured point cloud representation 75: a Fully Convolutional Network (FCN), a U-Net, a DeepLab CNN, and a Pyramid Scene Parsing Network (PSPNet). The mapping module 79 further includes a post-processing module 86 such that after the plurality of features present in the first captured point cloud representation 75 have been semantically segmented, the post-processing module 86 removes temporary features from the now semantically segmented first captured point cloud representation 88. In this way, only permanent features remain on the semantically segmented first captured point cloud representation 88. Temporary features may include, but are not limited to, parked vehicles 29 and traffic cones, while permanent features may include, but are not limited to, trees 31, sidewalks 39, buildings 89, traffic lights (not shown), and parking lines 27.

After the plurality features have been semantically segmented and the temporary features have been removed from the semantically segmented first captured point cloud representation 88, the post-processing module 86 aligns and stitches the semantically segmented first captured point cloud representation 88 onto a global map formed of a plurality of previously generated maps 87. The post-processing module 86 uses the first odometry information 77 to determine a location of the semantically segmented first captured point cloud representation 88 relative to the plurality of previously generated maps 86 forming the global map. Further, the post-processing module 86 aligns and stitches the semantically segmented first captured point cloud representation 88 with the previously generated plurality of maps 87 by matching identified features, such as buildings 89, paved surfaces 13 (i.e., streets and roads), and entrances and/or exits. Finally, the mapping module 79 generates a map 87 of the external environment 11 that has been aligned and stitched to the plurality of previously generated maps 87 that form the global map.

In Step 670, the second transceiver 55 transmits the generated map 87 of the external environment 11 to a second vehicle 59. The second transceiver 55 of the server 51 receives data from the first vehicle 15, and transmits data to the second vehicle 59. In addition, and as discussed below, the second transceiver 55 of the server 51 may receive data from the second vehicle 59 as well. The first vehicle 15 and the second vehicle 59 are typically not in direct communication, and thus contact is directed through the second transceiver 55 of the server 51. Further, the first transceiver 49, the second transceiver 55, and the third transceiver 71 are connected via a wireless data connection 73 that may be embodied as a cellular data connection, Wi-Fi, WiMAX, Vehicle-to-Everything (V2X), or equivalent data transmission protocols.

In Step 680, a third transceiver 71 of the second vehicle 59 receives the generated map 87 from the server 51. As previously discussed, the third transceiver 71 of the second vehicle 59 typically receives the generated map 87 from the second transceiver 55 of the server 51, however, the third transceiver 71 may additionally transmit a second captured point cloud representation 93 of an external environment 11 of the second vehicle 59. This scenario may occur if the localization process of the second vehicle 59 results in a confidence level less than a predetermined threshold, as previously discussed in relation to FIGS. 5A-5D. Confidence levels less than the threshold may occur when features have been removed, added, or repositioned within an external environment 11. Typically, this will result in unclassified features on the second captured point cloud representation 93. Accordingly, if the confidence level from the localization process of the second vehicle 59 is less than the predetermined threshold, the second captured point cloud representation 93 may be transmitted to the server 51 and an updated map 87 is generated.

In Step 690, at least a second imaging sensor 61 of the second vehicle 59 captures a second point cloud representation 93 of the external environment 11 of the second vehicle 59. Similar to the first imaging sensor 17, the second imaging sensor 61 may comprise at least one of: a LiDAR sensor, a camera, a radar sensor, and an infrared sensor. Additionally, the second vehicle 59 is not limited to only a second imaging sensor 61, and may include additional imaging sensors. The second imaging sensor 61 is configured to capture a second point cloud representation 93 for the purpose of comparing it to the generated map 87, and the second vehicle 59 is subsequently localized on the generated map 87.

In Step 700, at least a second vehicle position sensor 63 measures second odometry information related to an orientation, a velocity, and an acceleration of the second vehicle 59. Similar to the first vehicle position sensor 19, the second vehicle position sensor 63 may include a GNSS unit, a GPS RTK unit, an IMU, and/or a wheel encoder. In addition, the second vehicle 59 may comprise one or more vehicle position sensors. Further, the second vehicle 59 may use the second odometry information to assist in localizing the second vehicle 59 on the generated map 87. The orientation and position of the second vehicle 59, as well as the distance between various features, may be used to successfully align the generated map 87 with the second captured point cloud representation 93 in order to localize the second vehicle 59.

Finally, Step 710 includes localizing the second vehicle 59 on the generated map. Initially, a third processor 69 of the second vehicle 59 receives the second captured point cloud representation 93 of the external environment 11 from at least the second imaging sensor 61 and the generated map 87 from the third transceiver 71. A third memory 67 of the second vehicle 59 stores the second captured point cloud representation 93 of the external environment 11 and the generated map 87. Similar to the first and second memories, the third memory 67 of the second vehicle 59 is formed as a non-transient storage medium such as flash memory, RAM, a HDD, a SDD, a combination thereof, or equivalent devices.

The third processor 69 is further configured to localize the second vehicle 59 on the generated map 87 based on the second captured point cloud representation of the external environment 93 and the second odometry information. As previously described in FIGS. 5A-5D, the third processor 69 merges and aligns the generated map 87 with the second captured point cloud representation 93, with the assistance of the second odometry information. In this way, the currently unclassified features present in the second captured point cloud representation 93 are aligned with the semantically segmented features in the same location in the generated map 87, such that the unclassified features assume the classifications of the corresponding semantically segmented features. Accordingly, the second captured point cloud representation 93 then comprises a plurality of features that are classified, and the second vehicle 59 is localized using a localization algorithm stored on the second vehicle 59. More specifically, the localization process may include localization algorithms such as Monte Carlo localization, scan matching, or equivalent algorithms, and the localization algorithm is stored on the third memory 67 and executed by the third processor 69 of the second vehicle 59. As previously discussed, if merging the second captured point cloud representation 93 with the generated map 87 results in a confidence level less than an operator specified value, the second captured point cloud representation 93 may be transmitted to the server 51 in order to generate an updated map 87.

Although only a few example embodiments have been described in detail above, those skilled in the art will readily appreciate that many modifications are possible in the example embodiments without materially departing from this invention. Alternative embodiments may include performing the entirety of the process with a single vehicle that transmits a point cloud representation to a server and receives a semantically segmented map therefrom. In addition, many modifications will be appreciated by those skilled in the art to adapt a particular component, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including. ” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the reciting of the composition element, or elements and vice versa.

Unless otherwise indicated, all numbers expressing quantities used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. A point cloud based semantic segmentation system comprising:
a first vehicle configured to traverse an external environment, the first vehicle comprising:
at least a first imaging sensor configured to capture a first point cloud representation of the external environment;
at least a first vehicle position sensor configured to measure first odometry information related to an orientation, a velocity, and an acceleration of the first vehicle;
a first Electronic Control Unit (ECU) comprising:
a first processor configured to:
receive the first captured point cloud representation of the external environment from at least the first imaging sensor;
associate a location of the first captured point cloud representation of the external environment with a location of the first vehicle on Earth based on the first odometry information;
a first memory configured to store the first captured point cloud representation of the external environment;
a first transceiver configured to transmit the first captured point cloud representation;
a server configured to generate a map of the external environment, the server comprising:
a second transceiver configured to receive the first captured point cloud representation of the external environment from the first vehicle;
a second memory configured to store a mapping module comprising computer readable code;
a second processor configured to execute the computer readable code forming the mapping module, where the computer readable code causes the second processor to:
perform semantic segmentation on a plurality of features in the first captured point cloud representation;
generate the map of the external environment including the semantically segmented features of the first captured point cloud representation;
a second vehicle configured to localize the second vehicle on the generated map of the external environment, the second vehicle comprising:
at least a second imaging sensor configured to capture a second point cloud representation of the external environment;
at least a second vehicle position sensor configured to measure second odometry information related to an orientation, a velocity, and an acceleration of the second vehicle;
a second ECU comprising:
a third transceiver configured to receive the generated map of the external environment from the server;
a third memory configured to store the second captured point cloud representation of the external environment and the generated map;
a third processor configured to:
receive the second captured point cloud representation of the external environment from at least the second imaging sensor;
localize the second vehicle on the generated map of the external environment based on the second captured point cloud representation of the external environment and the second odometry information.

2. The system of claim 1, wherein the server is further configured to transmit classification labels associated with identified features to the second vehicle as part of the generated map.

3. The system of claim 1, wherein the first transceiver and the third transceiver are connected to the second transceiver via a data connection comprising: a Wireless-Fidelity (Wi-Fi) connection, a Worldwide Interoperability for Microwave Access (WiMAX) connection, a Vehicle to Everything (V2X) connection, a Fourth Generation (4G) Long-Term Evolution (LTE) connection, a Fifth Generation (5G) connection, a Bluetooth connection, a Light Fidelity (Li-Fi) connection, or a cellular connection.

4. The system of claim 1, wherein the first imaging sensor and the second imaging sensor each comprise at least one of: a camera, a LiDAR sensor, a radar sensor, and an ultrasonic sensor.

5. The system of claim 1, wherein the server is further configured to label unclassified features in the second captured point cloud representation.

6. The system of claim 5, wherein the third transceiver of the second vehicle is further configured to upload the second captured point cloud representation to the server in order to update the generated map with new and unclassified features.

7. The system of claim 1, wherein the mapping module of the server performs semantic segmentation of the plurality of features using at least one of the following Convolutional Neural Networks (CNNs): a Fully Convolutional Network (FCN), a U-Net, a DeepLab CNN, and a PSPNet.

8. The system of claim 1, wherein the plurality of features in the external environment of the first vehicle and the second vehicle comprise one or more of: parking lines, traffic signs, buildings, pillars, sidewalks, trees, one or more traffic light(s), and grass.

9. The system of claim 1, wherein the first vehicle position sensor and the second vehicle position sensor comprise at least one of: a Global Navigation Satellite Systems (GNSS) unit, a Global Positioning System (GPS) Real Time Kinematics (RTK) unit, an Inertial Measurement Unit (IMU), and a wheel encoder.

10. The system of claim 1, wherein the generated map comprises a state, a county, or a city in which the second vehicle is located.

11. The system of claim 1, wherein the mapping module of the server is further configured to remove temporary features from the map, where temporary features include at least one of: parked vehicles, traffic cones, barriers and barricades, portable traffic signs, construction equipment, temporary traffic lights, flashing warning lights, temporary crosswalks, temporary road surfaces, water-filled barriers, temporary lane markers, portable speed bumps, event-related objects, and traffic vehicles.

12. A method comprising:
capturing, via at least a first imaging sensor, a first point cloud representation of an external environment of a first vehicle;
measuring, via at least a first vehicle position sensor, first odometry information related to an orientation, a velocity, and an acceleration of the first vehicle;
receiving, via a first processor, the first captured point cloud representation of the external environment from at least the first imaging sensor;
storing, via a first memory, the first captured point cloud representation of the external environment;
associating, via the first processor, a location of the first captured point cloud representation of the external environment with a location of the first vehicle on Earth based on the first odometry information;
transmitting, via a first transceiver, the first captured point cloud representation to a server;
receiving, via a second transceiver, the first captured point cloud representation of the external environment from the first vehicle to the server;
storing, via a second memory, a mapping module comprising computer readable code on the server;
executing, via a second processor, the computer readable code forming the mapping module, where the mapping module comprises:
semantically segmenting a plurality of features in the first captured point cloud representation;
generating a map of the external environment including the semantically segmented features of the first point cloud representation;
receiving, via a third transceiver of a second vehicle, the generated map of the external environment from the server;
capturing, via at least a second imaging sensor, a second point cloud representation of the external environment of the second vehicle;
measuring, via at least a second vehicle position sensor, second odometry information related to an orientation, a velocity, and an acceleration of the second vehicle;
receiving, via a third processor, the second captured point cloud representation of the external environment from at least the second imaging sensor;
storing the second captured point cloud representation of the external environment and the generated map on a third memory;
localizing, via the third processor, the second vehicle on the generated map of the external environment based on the second captured point cloud representation of the external environment and the second odometry information.

13. The method of claim 12, further comprising: connecting the first transceiver and the third transceiver to the second transceiver via a data connection comprising: a Wireless-Fidelity (Wi-Fi) connection, a Worldwide Interoperability for Microwave Access (WiMAX) connection, a Vehicle to Everything (V2X) connection, a Fourth Generation (4G) Long-Term Evolution (LTE) connection, a Fifth Generation (5G) connection, a Bluetooth connection, a Light Fidelity (Li-Fi) connection, or a cellular connection.

14. The method of claim 12, further comprising: labelling unclassified features in the second captured point cloud representation via the second vehicle.

15. The method of claim 14, further comprising: uploading, via the third transceiver, the second captured point cloud representation to the server in order to update the generated map with any new and unclassified features.

16. The method of claim 12, wherein performing semantic segmentation of the plurality of features via the mapping module of the server comprises at least one of the following Convolutional Neural Networks (CNNs): a Fully Convolutional Network (FCN), a U-Net, a DeepLab CNN, and a PSPNet.

17. The method of claim 12, further comprising: removing, via the mapping module of the server, temporary features from the map, where temporary features include at least one of: parked vehicles, traffic cones, and traffic vehicles.

18. The method of claim 12, wherein associating a location of the first captured point cloud representation of the external environment further comprises determining a Global Navigation Satellite Systems (GNSS) location of the first vehicle.

19. The method of claim 12, wherein the generated map comprises a state, a county, or a city in which the second vehicle is located.

20. The method of claim 12, further comprising transmitting semantic masks to the second vehicle with the server as part of the generated map.
